(19) United States
(12) Patent Application Publication
(10) Pub. No.: US 2019/0014746 A1
(43) Pub. Date: Jan. 17, 2019

(54) Pet Toy with Laser Light and Multiple Teasers

(71) Applicant: The KONG Company, LLC, Golden, CO (US)

(72) Inventors: Sabina Crane, San Clemente, CA (US); Michele Helwig-Nelson, Castle Rock, CO (US)

(21) Appl. No.: 16/035,111

(22) Filed: Jul. 13, 2018

Related U.S. Application Data
(60) Provisional application No. 62/532,260, filed on Jul. 13, 2017.

(51) Int. Cl. A01K 15/02

(52) U.S. Cl. CPC A01K 15/025

(57) ABSTRACT

A pet toy comprises a light source and at least one teaser. A “teaser” in one form includes a flexible piece of material attached to a base at one end with the opposite end being free for manipulation by a pet or the pet owner. The light source, such as a laser light, is incorporated in a handle or wand, and the laser light is emitted from a distal end of the wand. One or more teasers are attached near or at the distal end of the wand. One or more teasers in the form of plush elements may be attached to the wand by a selected length of a connector such as string or nylon line. A method is disclosed for entertaining an animal by use of the pet toy.

### CROSS REFERENCE TO RELATED APPLICATION

This application claims the benefit of and priority to U.S. Provisional Application No. 62/532,260, filed Jul. 13, 2018, the entire application of which is hereby incorporated by reference in its entirety.

### FIELD OF THE INVENTION

The invention relates to pet toys and more particularly, to a cat toy having a laser light to enhance stimulation of a cat for extended play.

### BACKGROUND OF THE INVENTION

The commercialization of pet toys has significantly increased over recent years. Large retail outlets provide abundant floor space for displaying a wide range of pet products. Pet toys can be found in many shapes and sizes, as well as made from different materials.

One general category of pet toys is chew toys made of a flexible or elastomeric material. Synthetic rubber, natural rubber, TPR, and combinations thereof are known materials. These toys, if made from quality materials, can withstand the biting action of an animal and keep the animal occupied for substantial periods. It is also known to place treats in these toys to further increase interaction with the animal.

Many pet toys produce sound by use of a “squeaker” element. The squeaker is typically held within the interior of the pet toy, and as the pet toy expands or contracts during contact by an animal, air flow through the squeaker produces sound.

Another category of pet toys is those generally referred to as “plush” toys. These toys have an outer shell made from a relatively soft and flexible material, such as cloth or fabric. Some plush toys may further include material woven into strands, such as nylon fibers. A plush toy is typically stuffed with a fibrous material such as woven polyester. The stuffing provides the pet toy with a desired thickness or bulk that enables the animal to hold the toy.

While chew toys may be particularly popular for dogs, cat toys are more typically plush toys and smaller in size than plush toys for dogs. Catnip or other scents may be added to the plush toy to increase stimulation of the cat for extended play.

A few prior art toys include the use of a laser light to visually stimulate an animal. A laser light source can project a concentrated beam of light over considerable distances. For cats, the erratic movement of the laser light may stimulate play. The pet owner can project the laser light on many different surfaces and may move the light in erratic and unpredictable ways to stimulate the cat.

While laser light sources are known for use in pet toys, there is a need for a pet toy that combines both the attributes of a laser light and a plush toy to provide a pet owner with additional ways in which to stimulate a pet. There is also a need to provide the combined feature pet toy that is simple but robust in construction. There is yet further a need to provide the combined feature pet toy in which there are many options available for selecting a desired type of plush toy.

The invention described herein overcomes many limitations in the prior art, yet incorporates a resilient, robust construction. The invention provides multiple sources of stimulation for an animal, yet the pet toy is relatively simple in design.

### SUMMARY OF THE INVENTION

According to one preferred embodiment of the invention, it includes a pet toy comprising a wand, a laser light source mounted within a plush element, and a flexible extension interconnecting the laser light source and the wand. The flexible extension may be made of cloth or another relatively soft, flexible material. A conductor electrically interconnects the laser light source with power, such as one or more batteries mounted in the wand. The conductor extends interiorly through the wand and the flexible extension thereby being protected.

According to another embodiment of the invention, it includes a laser light source, a handle or wand, and one or more teasers. A “teaser” as this term is used herein means one or more flexible pieces of material that are attached to a base at one end with the opposite end that freely hangs from the base. A teaser may also have attributes of a plush toy, i.e., the teaser can incorporate a soft and flexible shell material with a selected stuffing. In this embodiment, the laser light source is incorporated in the handle or wand, and the laser light is emitted from a distal end of the wand. One or more teasers are attached near or at the distal end of the wand. If the teasers include a plush type element, the plush element may be attached to the wand by a selected length of a connector such as twine, string, nylon line, or other flexible yet resilient length of material.

One type of plush element could include various shaped plush toys such as mice, birds, insects, or others. Another type of plush element could include a pompon or “fuzz ball”.

The lengths of the teasers and connectors may be approximately the same or different. The teaser material may include multiple strands, single strands, woven or shaped lengths of material, and others.

According to another preferred embodiment, the pet toy may include a plurality of teasers and at least one plush element suspended or hung from the flexible connector. The laser light source in this embodiment can be either incorporated in the distal end of the wand or within the at least one plush element.

The laser light source may include an on/off switch located near or at the proximal end of the wand for ease of use by the pet owner.

The laser light may include different colors and different patterns of projected light. For example, the laser light source may have one or more pre-programmed sequences enabling the pet owner to select from a desired light color, a desire projected light pattern, and a desired sequence of activation and deactivation of the light.

Considering the above described features of the invention, in one aspect, it may be considered a pet toy comprising: a handle; a wand connected to said handle; a flexible extension connected to said wand; a plush element connected to said flexible extension; a laser light source mounted in said plush element; a switch for operating the laser light source; and a power source electrically connected to said laser light source for powering said laser light source.

According to another aspect of the invention, it may be considered a pet toy comprising: a wand; a laser light source integral with said wand; a switch for operating the laser light source; a power source integral with said wand for powering said laser light source; and at least one teaser attached to said wand, said teaser being a flexible elongate piece of material that can be manipulated by movement of said wand.

Other aspects of the invention related to this first and/or second aspect of the invention may include: wherein said teaser has a length at least as long as a length of said wand; said wand is cylindrical in shape; said at least one teaser is selected from at least one of a helical strand of material, a feather, a pompon, or a textured piece of material; said laser light source directs a beam of laser light in a predetermined direction; said predetermined direction is substantially parallel with a longitudinal axis of said wand but offset from the longitudinal axis; said predetermined direction is substantially along a longitudinal axis of said wand; said predetermined direction is offset from a longitudinal axis of said wand; said toy further includes a cord attached at said distal end of said wand for securing said at least one teaser; and said toy further includes an attachment base secured to a free end of said cord, and said at least one teaser secured to said attachment base.

According to another aspect of the invention, it may be considered a method of entertaining an animal, comprising: providing a pet toy including: a wand; a laser light source; a switch for operating the laser light source; a power source for powering said laser light source; a flexible extension connected to the wand; a plush element extending from the flexible extension with the laser light source mounted in the flexible extension; said flexible extension being manipulated by movement of said wand; switching on the laser light source; manipulating the wand to cause the laser light source to move; and presenting the toy to the animal for interaction with the animal.

Other features and advantages of the invention will become apparent as the invention is further illustrated and described in conjunction with the drawings, detailed description, and claims.

### BRIEF DESCRIPTION OF THE DRAWINGS

FIG. 1 is a perspective view of a first embodiment of the invention;

FIG. 2 is a perspective view of another embodiment;

FIG. 3 is a partial cross sectional view of an embodiment to illustrate interior structural details of the invention;

FIG. 4 is a perspective view of another embodiment;

FIG. 5 is a perspective view of yet another embodiment; and

FIG. 6 is a partial cross sectional view of the embodiment of FIG. 5.

### DETAILED DESCRIPTION

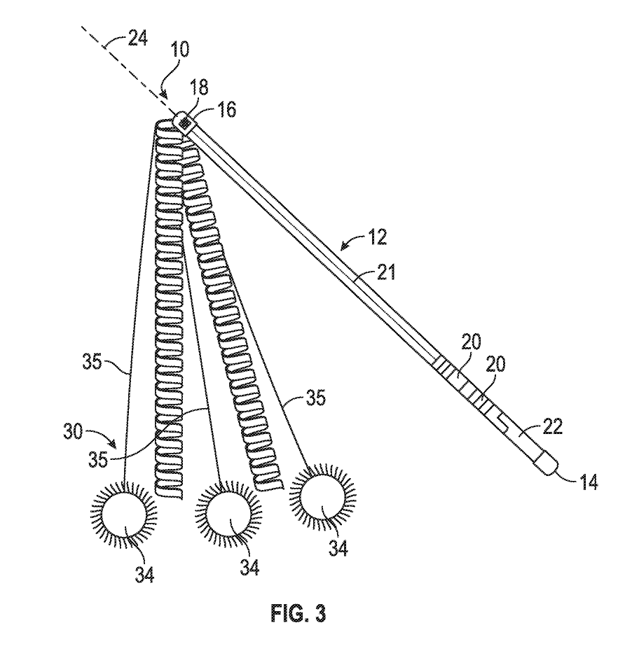

Referring to the figures, the invention is illustrated in the form of a pet toy 10. The toy includes an elongate member or wand 12 that houses elements of a laser emitting device. Referring specifically to the cross-sectional view of FIG. 3, a proximal end 14 of the wand 12 houses one or more batteries 20 and an on/off switch 22. An electrically conductive element such as one or more wires 21 interconnect the switch 22 and batteries 20 to a light emitting diode element 18 located at the distal or opposite end 16 of the wand. When the laser emitting device is switched on, a directed beam of laser light 24 is emitted from the distal end 16 of the wand.

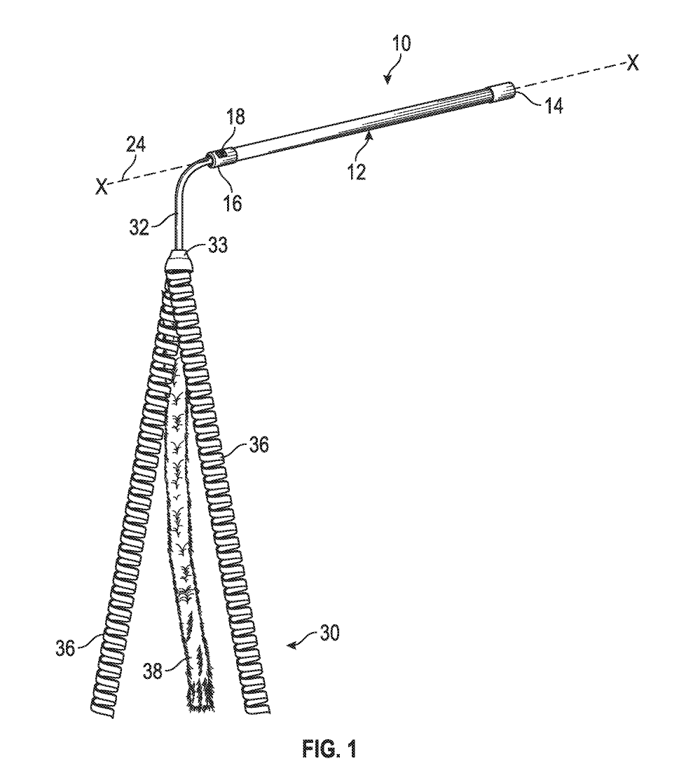

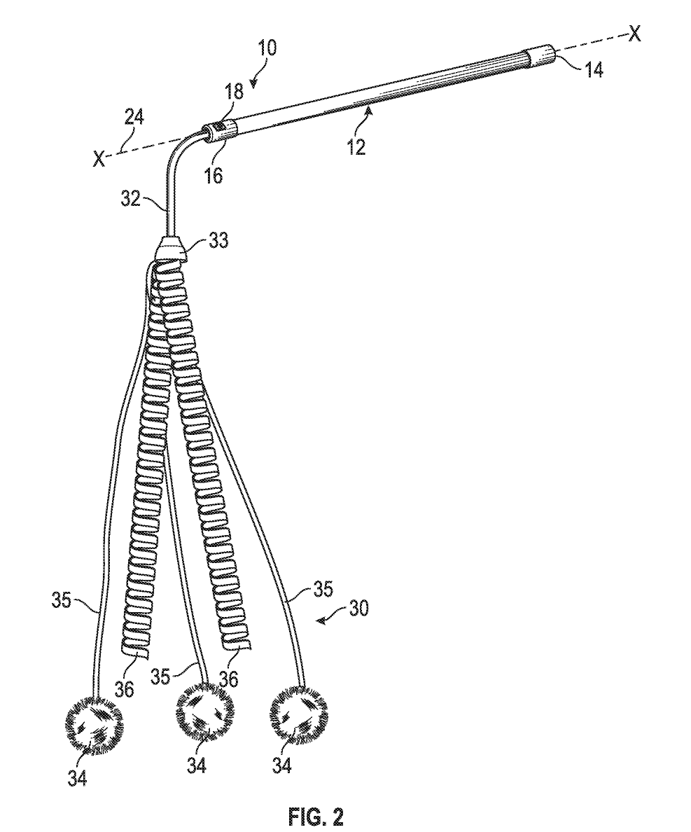

The directed beam of light can be selected to emit a beam in a desired direction. For example, referring to FIGS. 1 and 2, the beam of light may be emitted along a longitudinal axis X-X of the wand 12, along another axis parallel to but offset from the longitudinal axis X-X, or in a direction offset from the longitudinal axis X-X. The beam of light 24 as illustrated is intended to show either the beam of light directed parallel to but offset from the axis or directed along the axis X-X. Depending upon the size and orientation of the teasers 30, it may be advantageous to direct the beam of light offset from or parallel to the axis but not directed along the axis so the teasers will not interfere with the projected light beam.

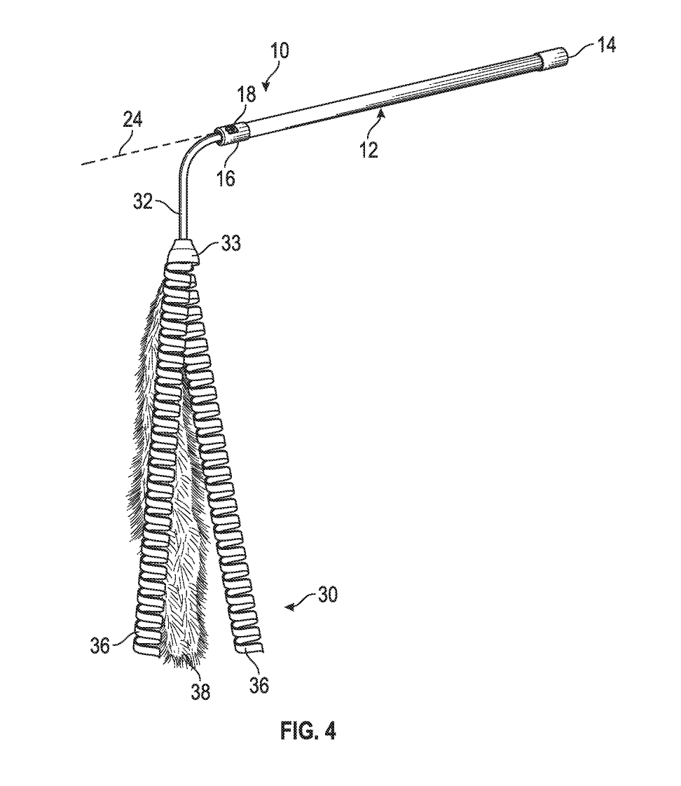

A plurality of teasers 30 are attached at or near the distal end 16 of the wand 12. The teasers 30 may take many shapes and configurations. The exemplary teasers illustrated in FIG. 1 include one or more helical strands of material 36 and one or more textured strands of material 38. In the embodiments of FIGS. 2 and 3, the teasers 30 illustrated include helical strands 36 and one or more pompons or fuzz balls 34 suspended by corresponding lines or strings 35. In the embodiment of FIG. 4, the teasers are illustrated as two helical strands 36 and an elongated feather 38.

The invention contemplates any number of combinations of different teasers to be incorporated with the wand 12. Accordingly, while a specific number and type of teasers are illustrated in the embodiments, these specific combinations should not be construed as the only combinations of teasers that may be employed.

In FIGS. 1, 2, and 4, the teasers 30 are tethered to the wand 12 by a flexible spring or cord 32. A base connector 33 is secured to the free end of the cord 32. The base connector 33 provides an attachment point for the teasers 30.

In FIG. 3, the teasers are attached directly to or near the distal end 16 of the wand 12. Either method of securing the teasers 30 to the wand may be used.

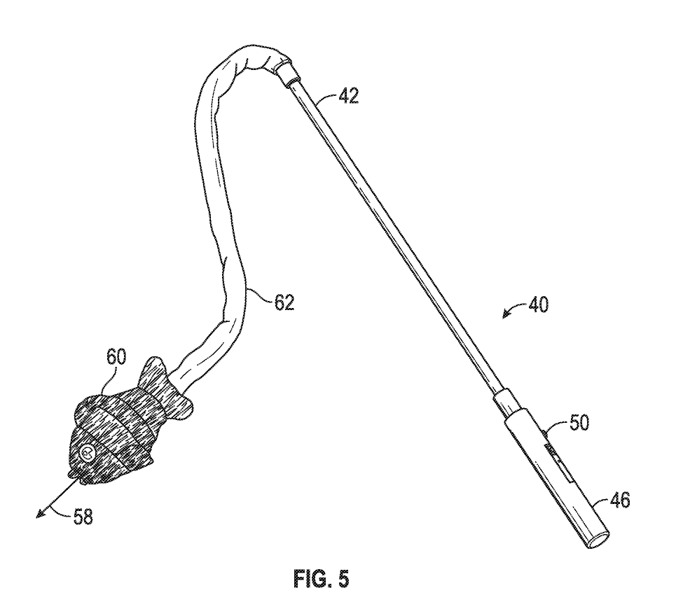

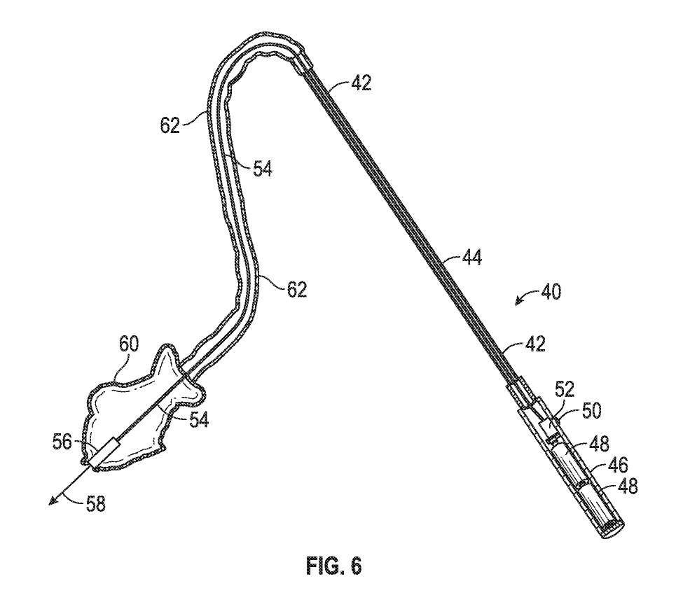

FIGS. 5 and 6 illustrate yet another embodiment of the invention in the form of a pet toy 40 also incorporating a laser emitting device. The pet toy 40 includes a handle 46 that houses one or more batteries 48 and a switch 52 that controls on/off control of the laser device 56. A push-button 50 protrudes from the handle 46 for control the switch 52 by a user. A wand 44 connects to the distal end of the handle 46, and a flexible extension 62 extends from the distal end of the wand 44. The wand and handle are made of relatively stiff material such as plastic, while the flexible extension 62 may be made of a softer material such as cloth. A first electrical conductor portion 44 extends through the wand 42. The extension 62 serves to protect a second electrical conductor portion 54 which connects to the first conductor portion 44 within the wand 42. The distal end of the extension 62 connects to a plush element 60, such as a soft and flexible member resembling an animal or other desired object. In the example of FIGS. 5 and 6, the plush element 60 resembles a fish. The laser device 56 as shown is positioned within the plush element and tip of the device 56 is exposed to enable the directed beam of light 58 from the laser device 60 to be projected beyond the plush element 60. Electrical power from the one or more batteries 48 is transmitted via the first and second conductor portions 44 and 54 to the laser device 56.

While the wand 42 and handle 46 are described as two separate elements in this preferred embodiment, it should be understood that the wand 42 and handle 46 may be more broadly considered as one integral element and collectively defined as a wand.

Although the light source described herein includes a light emitting diode to generate a laser light, other light sources may be substituted or may be used in addition to the laser light source. For example, a conventional fluorescent lamp may also be secured to the distal end of the wand and powered by the same batteries 20. Accordingly, the multiple light sources can be selected to be used simultaneously or one at a time.

According to a method of the invention, a pet owner selectively activates the switch 22 to generate the directed laser light 24 or other light source incorporated in the wand. The user then moves the wand causing the teasers 30 to follow the motion of the wand. The combination of the light and the moving action of the teasers has been shown to stimulate play with animals such as cats. The pet owner may shake or otherwise move the wand in an irregular movement pattern to generate the directed light beam onto a surface, and in response, the animal may attempt to capture or hold the moving light spot. This visual illusion of the light spot combined with movement of the teasers provides multiple sources of stimulation for the animal.

While the invention herein has been described with respect to one or more preferred embodiments, it shall be understood that various other changes or modifications to the invention may be made commensurate with the scope of the claims appended hereto.

What is claimed is:

1. A pet toy comprising:
a wand;
a light source integral with said wand;
a switch for operating the light source;
a power source integral with said wand for powering said light source; and
at least one teaser attached to said wand, said teaser being a flexible elongate piece of material that can be manipulated by movement of said wand.

2. A pet toy, as claimed in claim 1, wherein:
said teaser includes a plurality of teasers each having a length at least as long as a length of said wand.

3. A pet toy, as claimed in claim 1, wherein:
said wand is cylindrical in shape.

4. A pet toy, as claimed in claim 1, wherein:
said at least one teaser is selected from at least one of a helical strand of material, a feather, a pompon, or a textured piece of material.

5. A pet toy, as claimed in claim 1, wherein:
said light source directs a beam of laser light in a predetermined direction.

6. A pet toy, as claimed in claim 5, wherein:
said predetermined direction is substantially parallel with a longitudinal axis of said wand but offset from the longitudinal axis.

7. A pet toy, as claimed in claim 5, wherein:
said predetermined direction is substantially along a longitudinal axis of said wand.

8. A pet toy, as claimed in claim 5, wherein:
said predetermined direction is offset from a longitudinal axis of said wand.

9. A pet toy, as claimed in claim 1, further including:
a cord attached at said distal end of said wand for securing said teasers.

10. A pet toy, as claimed in claim 9, further including:
an attachment base secured to a free end of said cord, and said at least one teaser secured to said attachment base.

11. A method of entertaining an animal, comprising:
providing a pet toy including: a wand; a light source; a switch for operating the light source; a power source integral with said wand for powering said light source; a flexible extension connected to a distal end of said wand, and a plush element connected to a distal end of said flexible extension; said flexible extension being manipulated by movement of said wand;
switching on the light source;
manipulating the wand to cause the light source to move with said plush element; and
presenting the toy to the animal for interaction with the animal.

12. A pet toy comprising:
a handle;
a wand connected to said handle;
a flexible extension connected to said wand;
a plush element connected to said flexible extension;
a laser light source mounted in said plush element;
a switch for operating the laser light source; and
a power source electrically connected to said laser light source for powering said laser light source.

13. A pet toy, as claimed in claim 12, wherein:
said power source is integral with said handle.

14. A pet toy, as claimed in claim 12, wherein:
said plush element is made from a cloth material.
